(19) United States
(12) Patent Application Publication
(10) Pub. No.: US 2013/0073880 A1
(43) Pub. Date: Mar. 21, 2013

(54) POWER CONSUMPTION MEASURING APPARATUS, POWER CONSUMPTION MEASURING METHOD, AND MEMORY MEDIUM

(71) Applicant: Tohru MIYAZAKI, Osaka-shi (JP)

(72) Inventor: Tohru MIYAZAKI, Osaka-shi (JP)

(73) Assignee: NEC System Technologies, Ltd., Osaka (JP)

(21) Appl. No.: 13/614,777

(22) Filed: Sep. 13, 2012

(30) Foreign Application Priority Data
Sep. 16, 2011 (JP) 2011-202695

(51) Int. Cl. G06F 1/26

(52) U.S. Cl. 713/300

(57) ABSTRACT

A load measuring unit obtains load information on a configuring device. A status obtaining unit obtains status information of the configuring device based on the load information received from the load measuring unit. A learning unit learns actual power consumption based on actual power consumption received by a receiver unit, the load information obtained by the load measuring unit, and the status information obtained by the status obtaining unit. An estimating unit obtains estimated power consumption based on a learning result by the learning unit, the load information obtained by the load measuring unit, and the status information obtained by the status obtaining unit.

### INCORPORATION BY REFERENCE

This application is based on Japanese Patent Application No. 2011-202695 filed on Sep. 16, 2011, and including specification, claims, drawings and summary. The disclosure of the above Japanese Patent Application is incorporated herein by reference in its entirety.

### TECHNICAL FIELD

The present invention relates to a power consumption measuring apparatus, a power consumption measuring method, and a program.

### BACKGROUND ART

Together with the promotion of the energy saving against the increase of energy consumption, a system is demanded which is capable of grasping the power consumption of an electronic apparatus used in an office or a home.

In general, a measuring instrument like a power meter is used to measure power. In order to measure the power consumption of an electronic apparatus used in an office or a home through such a measuring instrument, it is necessary to prepare the same number of measuring instruments as that of the electronic apparatuses, resulting in large costs. Hence, a technology is proposed which estimates the power consumption at low costs without the use of a measuring instrument like a power meter in an office or a home.

Unexamined Japanese Patent Application Kokai Publication No. 2007-034669 discloses a power consumption monitoring system which divides electronic apparatuses into a unit having a large contribution to the energy consumption and units other than the former unit, and which obtains the power consumption of the whole electronic apparatuses based on the power consumption of each unit.

### SUMMARY

According to the power consumption monitoring system disclosed by Unexamined Japanese Patent Application Kokai Publication No. 2007-034669, the power consumption of the whole electronic apparatuses is obtained without a consideration for the status of the component of the electronic apparatus. Hence, in the case of, for example, an electronic apparatus having a component that automatically changes a state to an energy saving state, the monitoring of the power consumption may be inaccurate.

More specifically, a hard disk drive (hereinafter, an HDD) currently available in the market has a function of automatically changing the state to an energy saving state when there is no communication from an end of a computer that refers to the HDD for a certain time. The power consumption monitoring system of Unexamined Japanese Patent Application Kokai Publication No. 2007-034669 is incapable of detecting whether or not the HDD is currently in the energy saving state even if the system has such an HDD, and the error between the actual power consumption and the obtained power consumption becomes large, resulting in an inaccurate monitoring.

Moreover, the power consumption monitoring system of Unexamined Japanese Patent Application Kokai Publication No. 2007-034669 obtains in advance the power consumption of each component and stores the obtained power consumption in a database. Accordingly, when, for example, the electronic apparatus is old which is used for several years and the power consumption of each component changes due to the aging deterioration, the monitoring of the power consumption becomes inaccurate.

The present invention has been made in view of such circumstances, and it is an exemplary object of the present invention to provide a power consumption measuring apparatus, a power consumption measuring method, and a program which enhance the measuring accuracy of power consumption.

To achieve the exemplary object, an exemplary aspect of the present invention provides a power consumption measuring apparatus that includes: a load measuring unit that obtains load information on a configuring device which configures a local power consumption measuring apparatus; a status obtaining unit that obtains status information on the configuring device based on the load information obtained by the load measuring unit; an actual power consumption obtaining unit that obtains actual power consumption actually consumed by the local power consumption measuring apparatus; a power consumption learning unit that obtains a correlation between the load information and the actual power consumption for each status information based on the load information obtained by the load measuring unit, the status information obtained by the status obtaining unit, and the actual power consumption obtained by the actual power consumption obtaining unit; and a power consumption estimating unit that obtains estimated power consumption of the local power consumption measuring apparatus from the correlation obtained by the power consumption learning unit based on the load information obtained by the load measuring unit, and the status information obtained by the status obtaining unit

To achieve the exemplary object, another aspect of the present invention provides a power consumption measuring method that includes: a load measuring step of obtaining load information on a configuring device which configures a local apparatus; a status obtaining step of obtaining status information on the configuring device based on the load information obtained through the load measuring step; an actual power consumption obtaining step of obtaining actual power consumption actually consumed by the local apparatus; a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and a power consumption estimating step of obtaining estimated power consumption of the local apparatus from the correlation obtained through the power consumption learning step based on the load information obtained through the load measuring step, and the status information obtained through the status obtaining step.

To achieve the exemplary object, the other aspect of the present invention provides a computer-readable memory medium having stored therein a program that allows a computer to execute: a load measuring step of obtaining load information on a configuring device which configures a local apparatus; a status obtaining step of obtaining status information on the configuring device based on the load information obtained through the load measuring step; an actual power consumption obtaining step of obtaining actual power consumption actually consumed by the local apparatus; a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and a power consumption estimating step of obtaining estimated power consumption of the local apparatus from the correlation obtained through the power consumption learning step based on the load information obtained through the load measuring step, and the status information obtained through the status obtaining step.

According to the present invention, the measuring accuracy of power consumption can be enhanced.

### BRIEF DESCRIPTION OF THE DRAWINGS

The object and other objects and advantages of the present invention will become more apparent upon reading of the following detailed description and the accompanying drawings in which:

FIG. 1 is a block diagram showing an illustrative configuration of a power consumption measuring apparatus according to a first embodiment of the present invention;

FIG. 2 is a diagram for explaining example data stored in a storing unit of the present invention;

FIG. 3 is a block diagram showing an illustrative hardware configuration of the power consumption measuring apparatus of the present invention;

FIG. 4 is a flowchart showing an illustrative power consumption learning process according to the first embodiment of the present invention;

FIG. 5A is a diagram for explaining a change in power consumption according to the power consumption measuring apparatus;

FIG. 5B is a diagram for explaining a change in status according to the power consumption measuring apparatus;

FIG. 6 is a diagram for explaining a relationship between power consumption and load information according to the power consumption measuring apparatus;

FIG. 7 is a diagram for explaining a relationship among power consumption, load information and status information according to the power consumption measuring apparatus;

FIG. 8 is a diagram for explaining a learning result through the power consumption learning process of the present invention;

FIG. 9 is a diagram for explaining an illustrative learning result stored in the storing unit of the present invention;

FIG. 10 is a flowchart showing an illustrative power consumption estimating process of the present invention;

FIG. 11 is a diagram for explaining estimated power consumption through the power consumption learning process of the present invention;

FIG. 12 is a block diagram showing an illustrative configuration of a power consumption measuring apparatus according to a second embodiment of the present invention; and

FIG. 13 is a flowchart showing an illustrative power consumption learning process according to the second embodiment of the present invention.

### EXEMPLARY EMBODIMENTS

An explanation will be given of embodiments of the present invention with reference to the accompanying drawings.

### First Embodiment

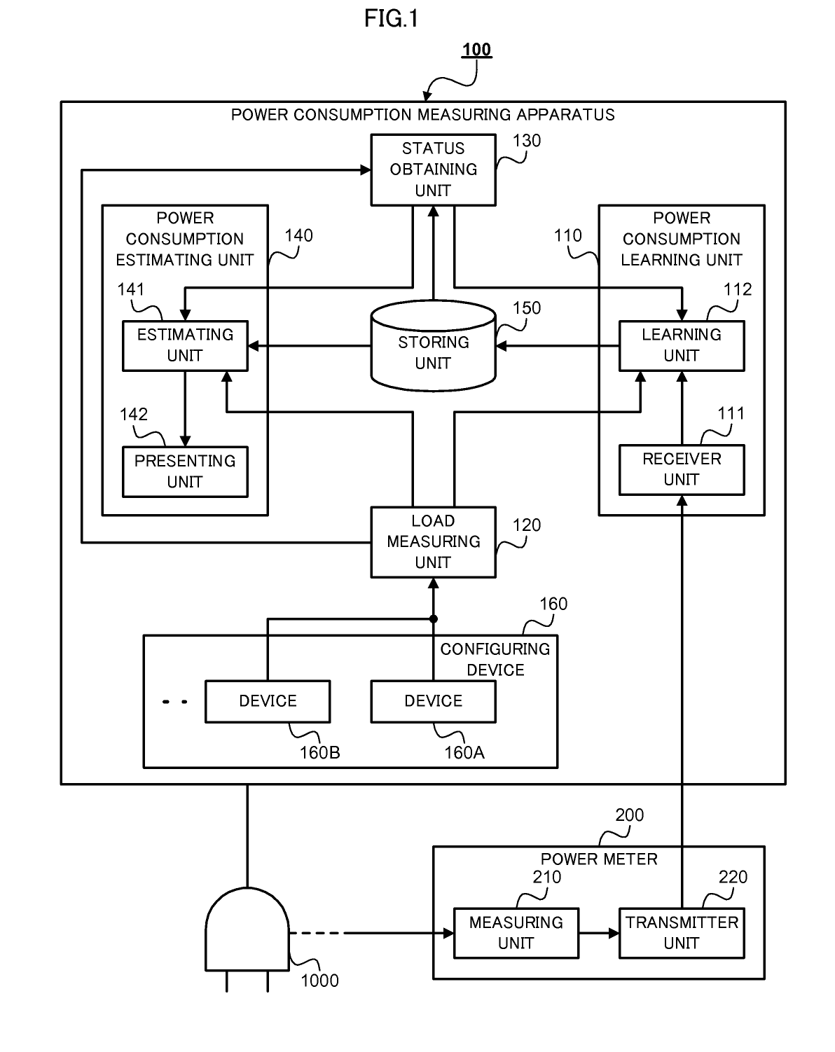

As shown in FIG. 1, a power consumption measuring apparatus 100 according to a first embodiment of the present invention includes a power consumption learning unit 110, a load measuring unit 120, a status obtaining unit 130, a power consumption estimating unit 140, a storing unit 150, and a configuring device 160, is subjected to measurement of power consumption, and is an electronic apparatus that learns and estimates power consumption of a local device.

The power consumption learning unit 110 includes a receiver unit 111, and a learning unit 112, and learns power consumption based on the power consumption of a local device.

The receiver unit 111 receives the actual power consumption of the power consumption measuring apparatus 100 transmitted from a power meter 200, and outputs the received actual power consumption to the learning unit 112.

The learning unit 112 learns the actual power consumption based on the actual power consumption received from the receiver unit 111, load information on the configuring device 160 received from the load measuring unit 120 to be discussed later, and status information on the configuring device 160 received from the status obtaining unit 130 to be discussed later, and stores a learning result in the storing unit 150. The learning result is a model and a parameter for estimating power consumption.

According to this embodiment, the learning unit 112 obtains a correlation between the load information and the actual power consumption for each piece of status information, and stores the obtained correlation in the storing unit 150. The correlation is a liner approximation formula for the load information and the actual power consumption.

The load measuring unit 120 obtains the load information on the configuring device 160, and outputs the obtained load information to the learning unit 112, the status obtaining unit 130 and an estimating unit 141.

The load information indicates loads to a device 160A, a device 160B and/or the like, included in the configuring device 160, and is, for example, a CPU use rate when the device 160A is a CPU (Central Processing Unit), or an HDD traffic when the device 160A is an HDD (Hard Disk Drive). According to this embodiment, in order to facilitate understanding to the present invention, the explanation will be given of a case in which the configuring device 160 includes the CPU and the HDD, and the load information obtained by the load measuring unit 120 is the CPU use rate and the HDD traffic.

The status obtaining unit 130 refers to a status table stored in the storing unit 150 to obtain the status information of the configuring device 160 based on the load information received from the load measuring unit 120, and outputs the obtained status information to the learning unit 112 and the estimating unit 141.

The status information indicates the status of the configuring device 160, and is, for example, information indicating a high power consumption status, or information indicating a low power consumption status. According to this embodiment, the status information is a status identifier uniquely identifying the status of the configuring device 160.

The power consumption estimating unit 140 includes the estimating unit 141 and a presenting unit 142, and estimates power consumption based on the learning result of power consumption.

The estimating unit 141 obtains power consumption based on the learning result of the learning unit 112 stored in the storing unit 150, the load information received from the load measuring unit 120, and the status information received from the status obtaining unit 130, and outputs the obtained power consumption (hereinafter, referred to as estimated power consumption) to the presenting unit 142.

The presenting unit 142 presents the estimated power consumption received from the estimating unit 141 to a user of the power consumption measuring apparatus 100.

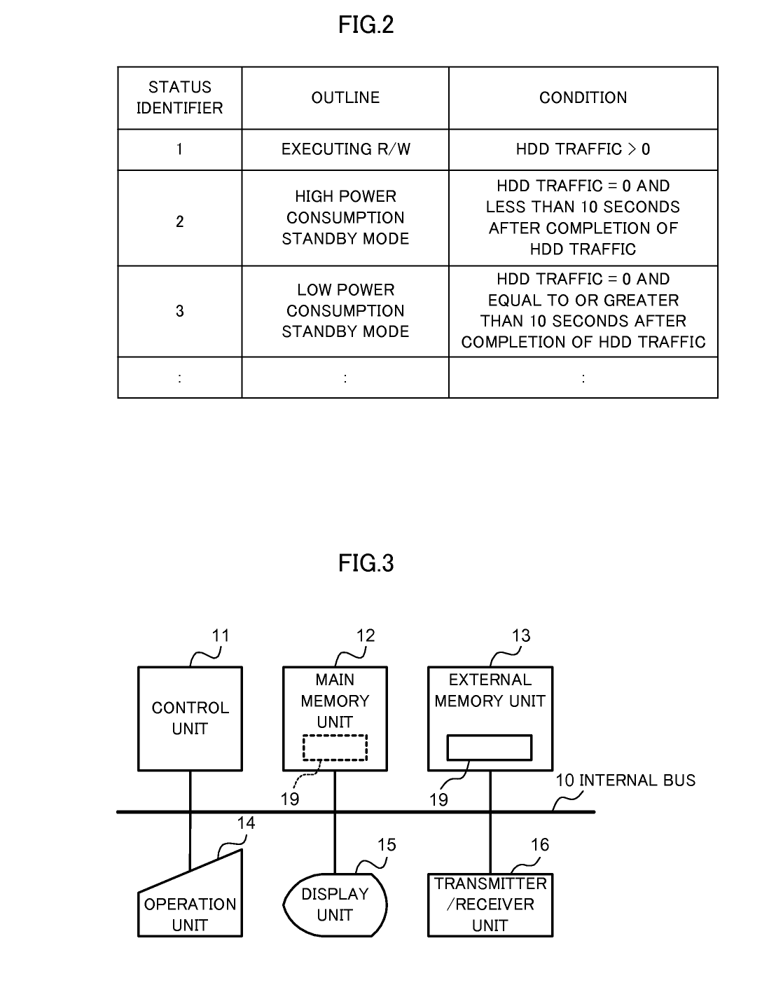

The storing unit 150 stores the learning result learned by the learning unit 112, and the status table for allowing the status obtaining unit 130 to obtain the status of the configuring device 160. As shown in FIG. 2, the status table associates the status identifier for uniquely identifying the status of the configuring device 160 with the condition of the load corresponding to such a status.

The configuring device 160 is a hardware configuring the power consumption measuring apparatus 100, and includes a plurality of devices. As explained above, according to this embodiment, the configuring device 160 includes the CPU and the HDD but the present invention is not limited to this configuration, and may further include a RAM, and a ROM and/or the like. Moreover, the number of the devices 160A, and 160B included in the configuring device 160 may be a multiple number.

The power meter 200 includes a measuring unit 210 and a transmitter unit 220, obtains the actual power consumption of the power consumption measuring apparatus 100, and transmits the obtained actual power consumption to the power consumption measuring apparatus 100.

The measuring unit 210 measures the actual power consumption of the power consumption measuring apparatus 100, and outputs the measured actual power consumption to the transmitter unit 220.

The transmitter unit 220 receives the actual power consumption from the measuring unit 210, and transmits the received actual power consumption to the power consumption measuring apparatus 100.

The power meter 200 is connected to a power plug 1000 of the power consumption measuring apparatus 100, and the measuring unit 210 obtains the actual power consumption through the power plug 1000. The power meter 200 may be a general power meter, but is not limited to any particular one as far as it can obtain the actual power consumption of the power consumption measuring apparatus 100 subjected to the measurement of the power consumption and transmit the obtained actual power consumption to the power consumption measuring apparatus 100.

The power consumption measuring apparatus 100 and the power meter 200 are connected with each other but it is fine if such an apparatus and a meter are connected with each other when the actual power consumption of the power consumption measuring apparatus 100 is measured, and it is unnecessary that such an apparatus and a meter are always connected with each other. Moreover, the connection scheme can be selected arbitrary depending on the configurations of the power consumption measuring apparatus 100 and the power meter 200, such as a serial connection or a network connection.

The above-explained configuration is the general configuration of the power consumption measuring apparatus 100.

Next, an explanation will be given of an illustrative hardware configuration of the power consumption measuring apparatus 100.

The power consumption measuring apparatus 100 includes, as shown in FIG. 3, a control unit 11, a main memory unit 12, an external memory unit 13, an operation unit 14, a display unit 15, and a transmitter/receiver unit 16. The main memory unit 12, the external memory unit 13, the operation unit 14, the display unit 15, and the transmitter/receiver unit 16 are all connected to the control unit 11 through an internal bus 10.

The transmitter/receiver unit 16 includes a serial interface or a LAN (Local Area Network) interface and/or the like. The transmitter/receiver unit 16 receives the actual power consumption transmitted from, for example, the power meter 200. Moreover, the transmitter/receiver unit 16 supplies the received actual power consumption to the control unit 11.

The external memory unit 13 includes a non-volatile memory, such as a flash memory, an HDD, a DVD-RAM (Digital Versatile Disc Random-Access Memory), or a DVD-RW (Digital Versatile Disc ReWritable), stores a program 19 in advance which causes the control unit 11 to execute respective processes to be discussed later, supplies data stored in the external memory unit 13 to the control unit 11, and stores data supplied from the control unit 11 in accordance with an instruction from the control unit 11. According to this embodiment, the external memory unit 13 is an HDD.

The main memory unit 12 includes a RAM (Random-Access Memory) and/or the like, reads the program 19 stored in the external memory unit 13, and is used as a work area for the control unit 11.

The control unit 11 includes a CPU, and executes respective processes to be discussed later in accordance with the program 19 stored in the external memory unit 13.

The operation unit 14 includes input devices, such as a keyboard and a mouse, operation keys and a touch panel, and an interface device that connects the input devices and/or the like, to the internal bus 10. The operation unit 14 has a function of processing an instruction given from the user, and supplies data input through an operation given by the user to the control unit 11.

The display unit 15 includes an LCD (Liquid Crystal Display) or an organic EL (Electro Luminescence) and/or the like. The display unit 15 displays the estimated power consumption and/or the like.

In FIG. 1, in order to facilitate understanding to the present invention, the power consumption learning unit 110, the load measuring unit 120, the status obtaining unit 130, the power consumption estimating unit 140, and the storing unit 150 are illustrated independently from the configuring device 160 including the CPU and the HDD, but those units are functional units realized upon execution of the program by the CPU.

The configuring device 160 is hardware shown in FIG. 3, and the power consumption measuring apparatus 100 is operated upon cooperative operations of such hardware and the power consumption learning unit 110, the load measuring unit 120, the status obtaining unit 130, the power consumption estimating unit 140, and the storing unit 150 shown in FIG. 1.

The above-explained configuration is an illustrative hardware configuration of the power consumption measuring apparatus 100.

Next, an explanation will be given of a power consumption learning process executed by the power consumption measuring apparatus 100. It is appropriated if the power consumption learning process is once executed at the time of, for example, shipping of the power consumption measuring apparatus 100, but the present invention is not limited to this case and the power consumption learning process may be executed through an operation given by the user.

The actual power consumption of the power consumption measuring apparatus 100 subjected to the measurement of power consumption is measured by the power meter 200. When measuring the actual power consumption of the power consumption measuring apparatus 100, the measuring unit 210 of the power meter 200 transmits the measured actual power consumption to the power consumption measuring apparatus 100 through the transmitter unit 220.

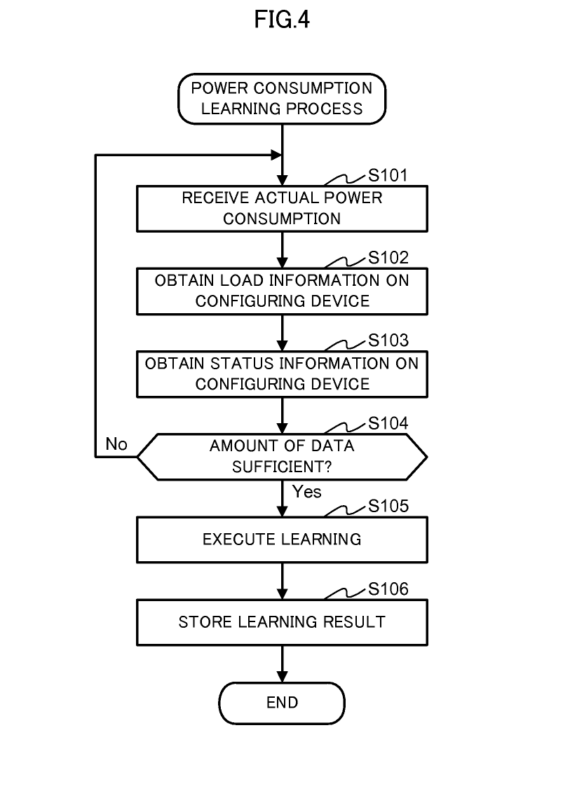

Upon reception of the actual power consumption from the power meter 200, the power consumption measuring apparatus 100 starts the power consumption learning process as shown in FIG. 4. When the receiver unit 111 receives the actual power consumption from the power meter 200 (step S101), the receiver unit 111 outputs the received actual power consumption to the learning unit 112.

The load measuring unit 120 obtains the load information on the configuring device 160 (step S 102), and outputs the obtained load information to the learning unit 112 and the status obtaining unit 130. That is, the load measuring unit 120 obtains the CPU use rate and the HDD traffic of the configuring device 160, outputs the CPU use rate to the learning unit 112, and outputs the HDD traffic to the status obtaining unit 130. However, the output destinations of the obtained load information are not limited to such units, and the CPU use rate and the HDD traffic may be output to the learning unit 112 and the status obtaining unit 130 without defining the output destinations.

Upon reception of the load information from the load measuring unit 120, the status obtaining unit 130 obtains the status information on the configuring device 160 based on the received load information and the status table stored in the storing unit 150 (step S103), and outputs the obtained status information to the learning unit 112. That is, the status obtaining unit 130 receives the HDD traffic from the load measuring unit 120, and obtains the status identifier corresponding to the received HDD traffic from the status table stored in the storing unit 150.

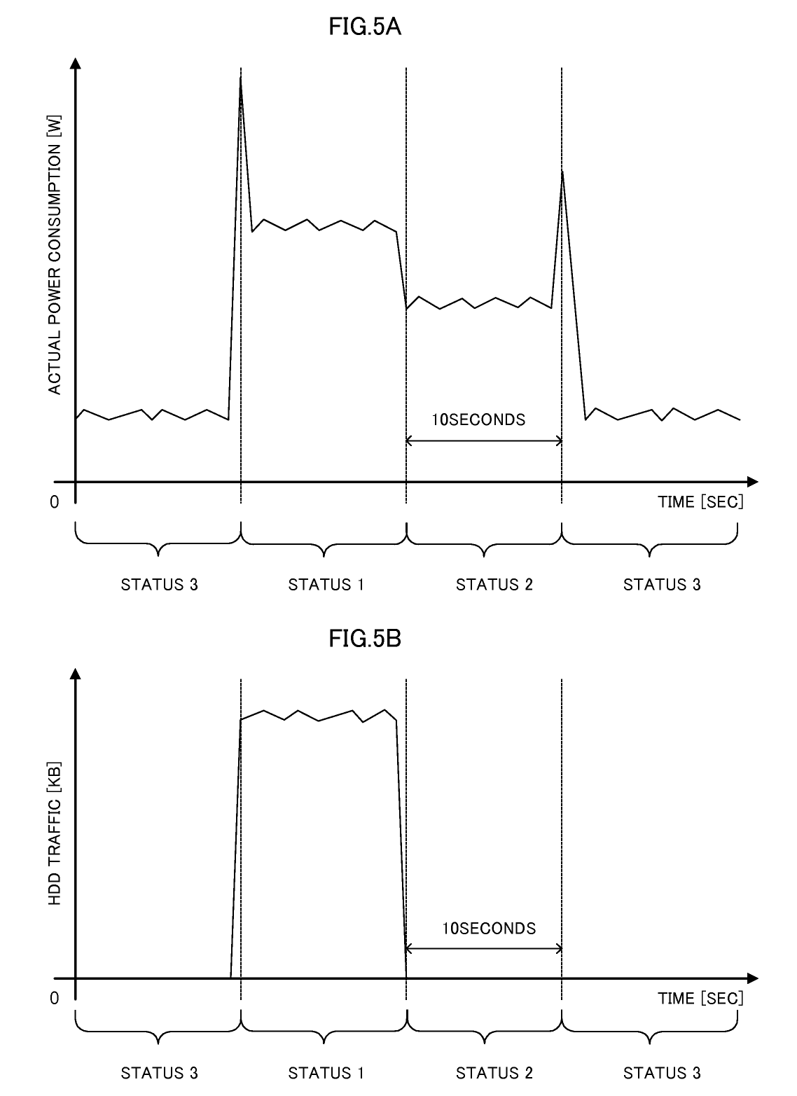

When, for example, as shown in FIG. 5A, the actual power consumption of the power consumption measuring apparatus 100 changes and as shown in FIG. 5B, the HDD traffic changes, the status obtaining unit 130 obtains the status identifier based on the HDD traffic obtained by the load measuring unit 120. That is, when, for example, the storing unit 150 stores the status table shown in FIG. 2, as shown in FIG. 5B, the status obtaining unit 130 obtains a status identifier “1”, “2” or “3”. More specifically, when the HDD traffic is larger than 0, the status obtaining unit 130 obtains the status identifier “1”. When the HDD traffic is 0 and a time after the completion of the HDD traffic is less than 10 seconds, the status obtaining unit 130 obtains the status identifier “2”. When the HDD traffic is 0 and the time after the completion of the HDD traffic is not less than 10 seconds, the status obtaining unit 130 obtains the status identifier “3”.

The power consumption measuring apparatus 100 has a time obtaining unit thereinside like a timer that can obtain time information, and each structural unit can obtain the time information through the time obtaining unit.

Returning to FIG. 4, the learning unit 112 determines whether or not sufficient data for learning power consumption is accumulated based on the actual power consumption received from the receiver unit 111, the load information received from the load measuring unit 120, and the status information received from the status obtaining unit 130 (step S104).

As explained above, according to this embodiment, the learning unit 112 obtains the correlation between the load information and the actual power consumption for each piece of status information. In order to obtain the correlation, a certain amount of data is necessary, and it is determined whether or not the necessary amount of data to obtain the correlation is accumulated. For example, regarding all statuses stored in the status table, if equal to or greater than 10 pieces of data on the actual power consumption when the CPU use rate is 0%, and equal to or greater than 10 pieces of data on the actual power consumption when the CPU use rate is 100% are obtained, the learning unit 112 determines that the sufficient amount of data is accumulated.

According to the above-explained determination, when it is determined that the accumulated data for learning is insufficient (step S104: No), the power consumption measuring apparatus 100 returns the process to the process of the step S101, and obtains various data again.

When determining that the accumulated data for learning is sufficient (step S104: Yes), the learning unit 112 learns the actual power consumption based on the actual power consumption received from the receiver unit 111, the load information received from the load measuring unit 120, and the status information received from the status obtaining unit 130 (step S105). Next, the learning unit 112 stores the learning result in the storing unit 150 (step S106), and terminates the process.

According to this embodiment, the CPU use rate and the HDD traffic are obtained as the load information, and the status identifier is obtained as the status information. The learning unit 112 obtains a liner approximation formula y=αx+β for each status identifier where x is the CPU use rate and y is the actual power consumption. In this case, α and β are parameters, respectively, and when N number of status identifiers are set, the learning unit 112 obtains 2×N number of parameters. Moreover, a least square technique is applied to obtain the approximation formula. The explanation below will be given of a case in which learning is executed through a linear approximation using the least square technique as explained above, but the learning scheme is not limited to this technique and is optional. For example, the learning unit 112 may execute learning through a polynomial approximation or an index approximation.

When the above-explained power consumption learning process completes, it becomes unnecessary to measure the actual power consumption of the power consumption measuring apparatus 100. That is, the power meter 200 becomes necessary only when the power consumption learning process is executed, and becomes unnecessary when a power consumption estimating process to be discussed later is executed. Hence, the power meter 200 may be detached from the power consumption measuring apparatus 100 after the power consumption learning process completes.

The above-explained process is the power consumption learning process executed by the power consumption measuring apparatus 100.

Next, an explanation will be given of the specific way of learning by the learning unit 112. An explanation will be given of an example case in which the storing unit 150 stores the status table shown in FIG. 2.

After starting the power consumption learning process, the power consumption measuring apparatus 100 causes the receiver unit 111 to receive the actual power consumption of the power consumption measuring apparatus 100 until the necessary data for learning is accumulated as explained above. The load measuring unit 120 obtains the CPU use rate and the HDD traffic as the load information. The status obtaining unit 130 obtains the status identifier as the status information based on the HDD traffic obtained by the load measuring unit 120. Those pieces of data are output to the learning unit 112.

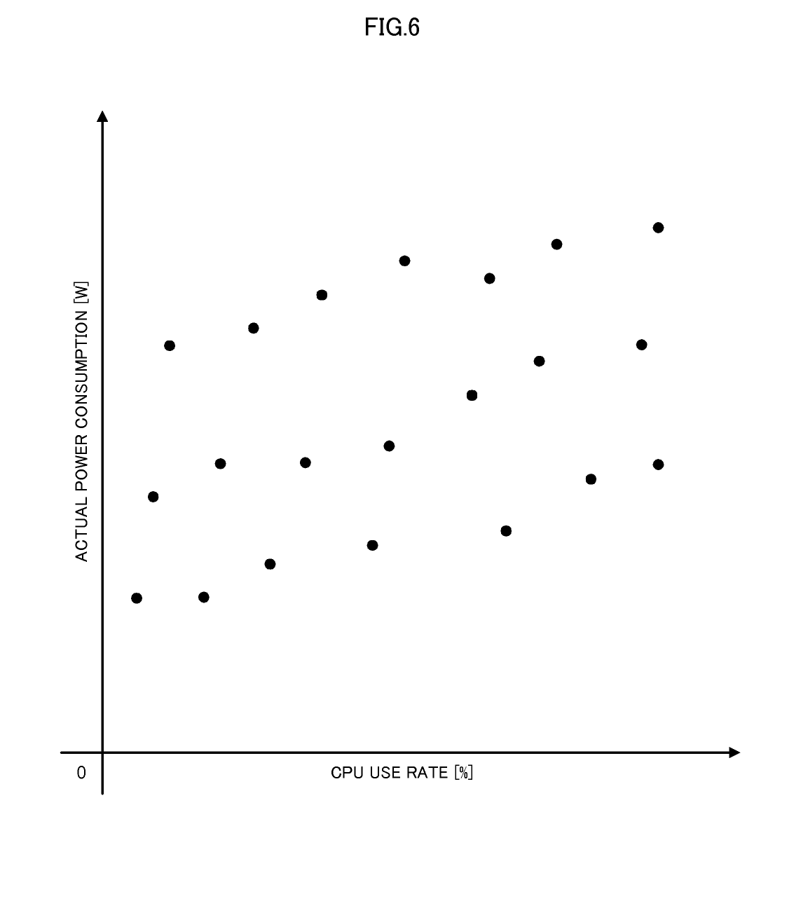

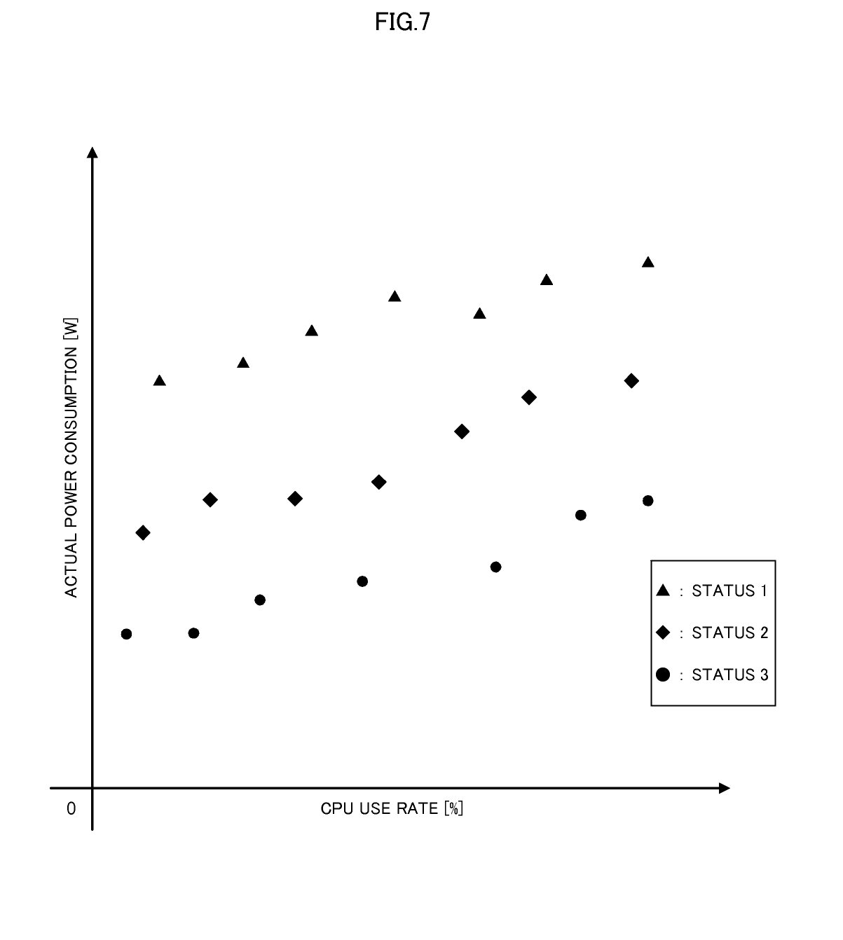

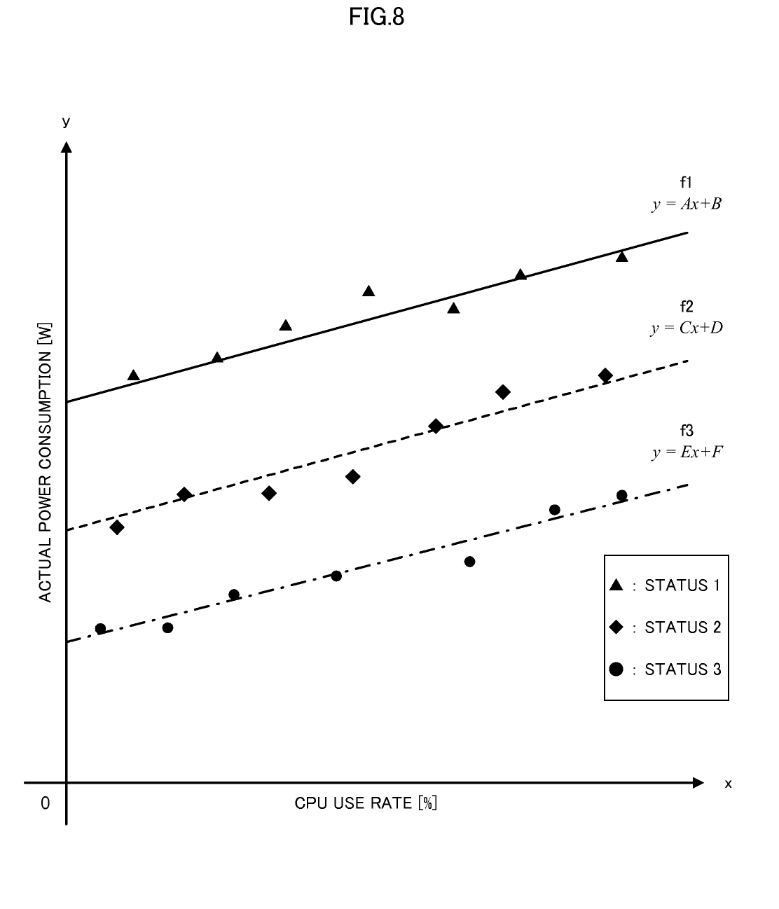

The CPU use rate and the actual power consumption that are input data to the learning unit 112 can be expressed as shown in FIG. 6. If the learning unit 112 attempts to carry out the learning based on only the CPU use rate and the actual power consumption, no sufficient correlation can be obtained, and the errors of respective parameters become large. Hence, according to this embodiment, the status identifier as the status information is used as input data to the learning unit 112, and the CPU use rate and the actual power consumption are classified based on the status identifier. When the CPU use rate and the actual power consumption are classified based on the status identifier, each piece of input data can be expressed as shown in FIG. 7. When the status identifier is “1”, i.e., at the time of the execution of R/W (reading/writing), the actual power consumption becomes highest, and when the status identifier is “3”, i.e., at the time of a low-power-consumption stand-by status, the actual power consumption becomes lowest.

The learning unit 112 performs learning based on the relationship among the CPU use rate, the actual power consumption and the status identifier shown in FIG. 7. That is, as shown in FIG. 8, the learning unit 112 obtains the linear approximation formula of the CPU use rate and the actual power consumption for each status identifier. An approximation formula f1 corresponding to the status identifier “1” is y=Ax+B. An approximation formula f2 corresponding to the status identifier “2” is y=Cx+D. An approximation formula f3 corresponding to the status identifier “3” is y=Ex+F.

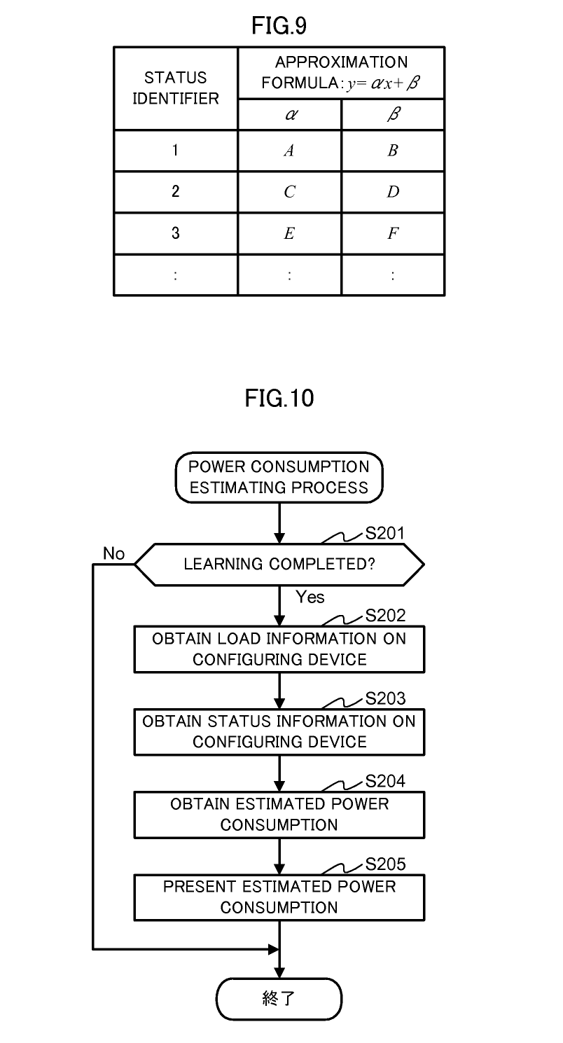

After obtaining the approximation formula, as shown in FIG. 9, the learning unit 112 stores, as a learning result, the parameters of the obtained approximation formula in the storing unit 150 in association with the status identifier. The power consumption measuring apparatus 100 executes a power consumption estimating process to be discussed later based on such a learning result.

The above-explained operation is the detail of the learning method of the learning unit 112.

Next, an explanation will be given of the power consumption estimating process by the power consumption measuring apparatus 100. The power consumption estimating process is executed at a predetermined timing (e.g., every 10 seconds), but may be executed through an operation given by the user.

The power consumption measuring apparatus 100 starts the power consumption estimating process as shown in FIG. 10 after the power consumption learning process.

The power consumption measuring apparatus 100 first determines whether or not the learning by the learning unit 112 completes by referring to the storing unit 150 (step S201). When the learning is not completed yet (step S201: No), the power consumption measuring apparatus 100 terminates the process. The power consumption measuring apparatus 100 determines whether or not the learning result is stored in the storing unit 150. When the learning result is stored, the power consumption measuring apparatus 100 determines that the learning is completed, and when no learning result is stored, determines that the learning is not completed yet.

When terminating the power consumption estimating process upon incompletion of the learning, the power consumption measuring apparatus 100 may present an error message to the user. Moreover, regarding the determination on whether or not the learning is completed, a learning completion flag may be set in the storing unit 150 after the completion of the power consumption learning process, and the determination may be made based on the learning completion flag.

When the learning by the learning unit 112 is completed (step S201: Yes), the load measuring unit 120 obtains the load information on the configuring device 160 (step S202), and outputs the obtained load information to the status obtaining unit 130 and the estimating unit 141. That is, the load measuring unit 120 obtains the CPU use rate and the HDD traffic of the power consumption measuring apparatus 100, outputs the CPU use rate to the estimating unit 141, and outputs the HDD traffic to the status obtaining unit 130.

Upon reception of the load information from the load measuring unit 120, the status obtaining unit 130 obtains the status information of the configuring device 160 based on the received load information and the status table stored in the storing unit 150 (step S203), and outputs the obtained status information to the estimating unit 141. That is, the status obtaining unit 130 receives the HDD traffic from the load measuring unit 120, and obtains the status identifier corresponding to the received HDD traffic from the status table stored in the storing unit 150.

The estimating unit 141 obtains estimated power consumption based on the learning result stored in the storing unit 150, the load information received from the load measuring unit 120, and the status information received from the status obtaining unit 130 (step S204), and outputs the obtained estimated power consumption to the presenting unit 142. That is, the estimating unit 141 obtains the approximation formula stored in the storing unit 150 based on the status identifier that is the status information, and applies the CPU use rate as the load information to the obtained approximation formula, thereby obtaining the estimated power consumption.

The presenting unit 142 presents the estimated power consumption received from the estimating unit 141 to the user (step S205), and terminates the process. Regarding the way of presenting the estimated power consumption by the presenting unit 142, any arbitrary schemes can be selected, such as displaying the estimated power consumption through the display unit 15, transmitting the estimated power consumption to a terminal device owned by the user through a network, and uploading data on the estimated power consumption to a server through a network and causing the user to refer to such data from another PC or the like.

The above-explained operation is the power consumption estimating process by the power consumption measuring apparatus 100.

Next, an explanation will be given of the specific estimating method by the estimating unit 141.

The estimating unit 141 obtains the estimated power consumption based on the learning result stored in the storing unit 150, the load information received from the load measuring unit 120, and the status information received from the status obtaining unit 130. As explained above, according to this embodiment, as the learning result, the correlation between the load information and the actual power consumption, i.e., the parameters of the approximation formula are stored in the storing unit 150, the CPU use rate is obtained as the load information and the status identifier is obtained as the status information.

First, the estimating unit 141 refers to the learning result stored in the storing unit 150 based on the status identifier, and obtains the approximation formula corresponding to the status identifier. For example, when obtaining the status identifier “3” from the status obtaining unit 130, the estimating unit 141 obtains the approximation formula f3 corresponding to the status identifier “3”.

Next, the estimating unit 141 substitutes the CPU use rate received from the load measuring unit 120 into the obtained approximation formula, and obtains power consumption derived from the approximation formula. Next, the estimating unit 141 outputs the obtained power consumption as the estimated power consumption to the presenting unit 142.

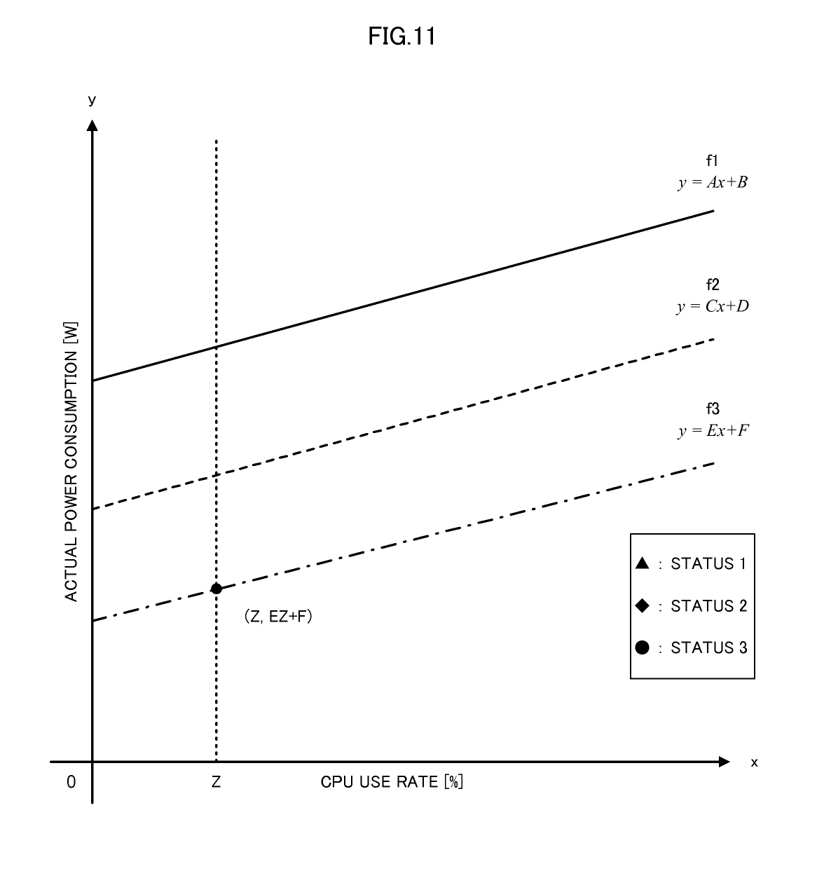

More specifically, for example, as explained above, it is presumed that the learning result by the learning unit 112 is a graph shown in FIG. 8 and parameters shown in FIG. 9. In this case, when the estimating unit 141 obtains a CPU use rate Z from the load measuring unit 120, and obtains the status identifier “3” from the status obtaining unit 130, the estimated power consumption obtained by the estimating unit 141 is, as shown in FIG. 11, an intersection between the straight line that is y=Z where Z is the CPU use rate and the approximation formula f3.

That is, in this case, the estimated power consumption obtained by the estimating 30 unit 141 is EZ+F that is a value obtained by substituting the CPU use rate Z into the approximation formula f3. This value is output as the estimated power consumption to the presenting unit 142, and is presented to the user.

The above-explained operation is the specific estimating method by the estimating unit 141.

As explained above, according to the power consumption measuring apparatus 100 of this embodiment, it is possible to determine the current status of the configuring device 160, and thus the power consumption in accordance with the current status of the configuring device 160 can be learned and estimated, thereby enhancing the measurement accuracy of the power consumption.

Moreover, according to the power consumption measuring apparatus 100 of this embodiment, since the power meter 200 is provided and the learning of the power consumption is executed in advance, the learning can be executed with the negative effect of the individual difference among the devices of the same kind being eliminated. Accordingly, the measurement accuracy of the power consumption is further enhanced.

Furthermore, according to the power consumption measuring apparatus 100 of this embodiment, the power consumption based on the load to the configuring device 160 can be learned at the time of the installation of the power consumption measuring apparatus 100. Hence, even if aging deterioration has been caused, the power consumption in consideration of the effect of the aging deterioration can be estimated, thereby enhancing the measurement accuracy of the power consumption.

Still further, according to the power consumption measuring apparatus 100 of this embodiment, once the power consumption learning process is completed at the time of, for example, shipping, the estimated power consumption can be obtained based on the learning result stored in the storing unit 150. Hence, when the power consumption measuring apparatus 100 is used in an office or a home, it is unnecessary to measure power consumption through a power meter and/or the like, and the power consumption can be estimated at low costs.

### Second Embodiment

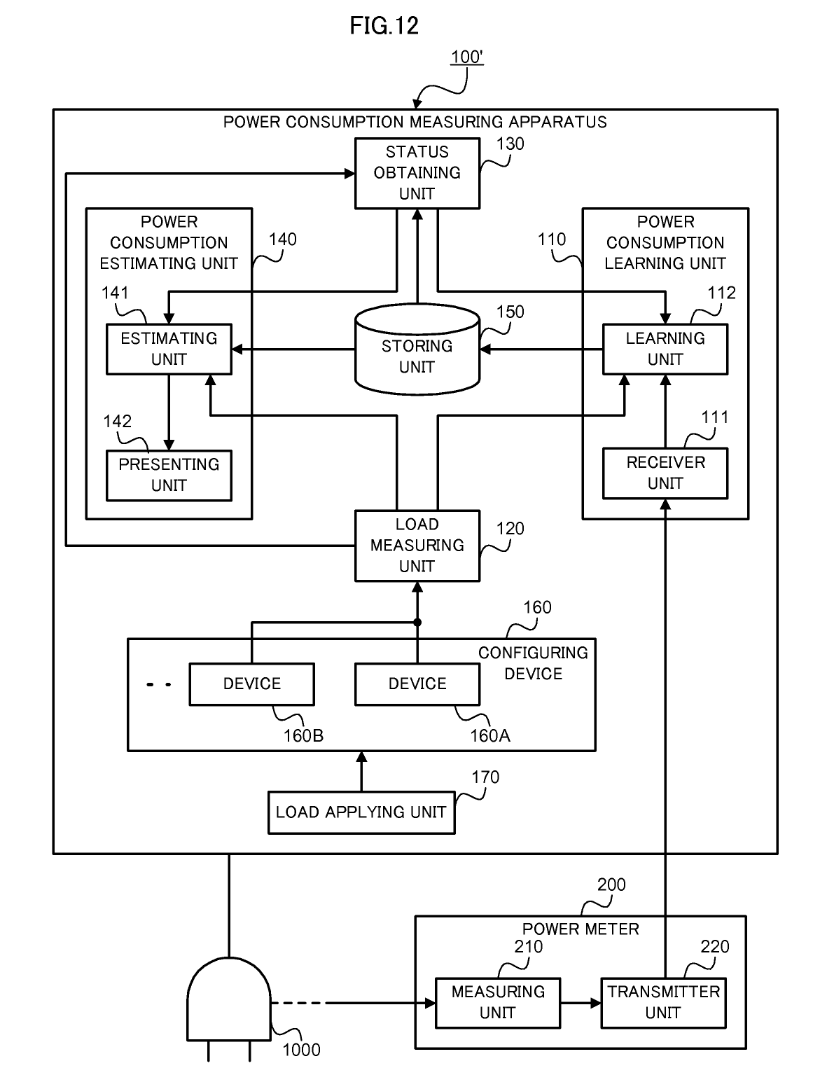

A power consumption measuring apparatus 100′ of a second embodiment of the present invention includes, as shown in FIG. 12, a load applying unit 170 in addition to the configuration of the power consumption measuring apparatus 100 of the first embodiment.

The load applying unit 170 applies predetermined load to the configuring device 160. That is, the load applying unit 170 controls the load to the configuring device 160. When, for example, the configuring device 160 includes the CPU and the HDD, the load applying unit 170 causes the CPU to execute an arithmetic operation instruction, to apply certain load thereto, and repeats writing and reading of empty data to apply certain load to the HDD.

The power consumption measuring apparatus 100′ includes the load applying unit 170, and thus being capable of actively applying load to the configuring device 160, thereby making the power consumption learning process efficient. An explanation will be given of how to make the power consumption learning process efficient.

First, the scope and the range of the amount of load are set in advance. The amount of load is a value indicating, for example, the CPU use rate and the HDD traffic. The scope of the amount of load is, for example, the scope of the CPU use rate, and the range of the amount of load is, for example, a range such as increasing of the CPU use rate by a unit of 5%. Such setting may be made by a user in advance, or set by a designer at the time of designing, and may be stored in the storing unit 150.

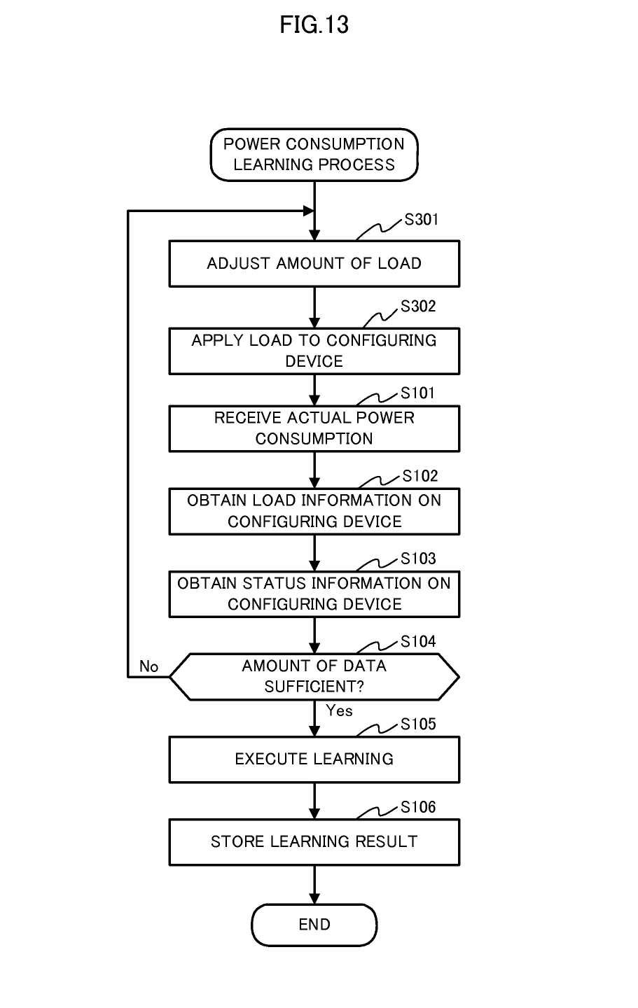

After starting the power consumption learning process, the power consumption measuring apparatus 100′ causes the load applying unit 170 to adjust the amount of load as shown in FIG. 13 (step S301). The load applying unit 170 selects the lowest amount of load at first, but increases the amount of load in accordance with the set range of the amount of load thereafter. Upon increasing of the amount of load, when it exceeds the scope of the amount of load, the load applying unit 170 selects the lowest amount of load again.

After adjusting the amount of load, the load applying unit 170 applies load to the configuring device 160 based on the adjusted amount of load (step S302). Regarding how to apply the load, any schemes, such as causing the CPU to execute an adequate arithmetic processing for a certain time, and adjusting the arithmetic processing time and the idling time, can be selected as needed.

After the load applying unit 170 has applied the load to the configuring device 160, the power consumption measuring apparatus 100′ executes the power consumption learning process similar to that of the first embodiment, but when the sufficient data necessary for learning is not accumulated yet, the process returns to step S301. That is, until the sufficient data necessary for learning is accumulated, the load applying unit 170 keeps applying the load to the configuring device 160 in accordance with the set scope and range of the amount of load.

The process by the load applying unit 170 and the power consumption learning process may be executed in a parallel manner. For example, the load applying unit 170 applies load to the configuring device 160 while increasing the amount of load step by step from the lowest amount of load for a certain period, and after the load based on the maximum amount of load is applied to the configuring device 160 for a certain time, the process can be terminated. During such operations, the power consumption learning process shown in FIG. 4 is sequentially executed.

In any cases, the power consumption measuring apparatus 100′ actively accumulates data necessary for learning, thereby accumulating necessary data for the learning efficiently. That is, the power consumption learning process of the power consumption measuring apparatus 100′ completes within a shorter time than that of the power consumption learning process by the power consumption measuring apparatus 100 according to the first embodiment.

The other configurations and operations of the power consumption measuring apparatus 100′ are consistent with those of the power consumption measuring apparatus 100 of the first embodiment.

### Modified Examples

The present invention was explained above with reference to the preferred embodiments, but the present invention is not limited to the above-explained embodiments, and can be changed and modified in various forms within the scope and spirit of the present invention. Moreover, the above-explained apparatus configurations and flowcharts are merely examples, and can be changed and modified as needed. An explanation will be given of modified examples of the above-explained embodiments to which the present invention can be applied.

According to the above-explained embodiments, the explanation was given of the case in which the configuring device 160 includes the CPU and the HDD and the load measuring unit 120 obtains the CPU use rate and the HDD traffic as the load information. The present invention is, however, not limited to the above-explained case, and a configuration may be employed in which the load information on the main memory unit 12 and the display unit 15 and/or the like, is obtained. When such a configuration is employed, the load measuring unit 120 obtains a RAM traffic and a screen brightness as the load information, and the status obtaining unit 130 obtains the status information based on such pieces of information. That is, the load information obtained by the load measuring unit 120 can be unique information to hardware originating from the actual power consumption, and is optional as far as the correlation between the status information of the configuring device 160 and the actual power consumption can be obtained based on the load information.

According to the above-explained embodiments, the explanation was given of the configuration in which the estimated power consumption is obtained through the power consumption estimating process based on the learning result obtained from the power consumption learning process. It is fine if the power consumption learning process is completed at the time of, for example, shipping of the power consumption measuring apparatus 100, but the configuring device 160 is affected by various environments, such as a temperature, an atmospheric pressure, and a humidity of a place where the device is disposed, and an error with the power consumption at the time of shipping may be caused. Hence, a configuration may be employed in which the power consumption learning process is executed again based on an operation given by the user or an instruction given by a manager through a network and/or the like, and the learning result stored in the storing unit 150 at the time of shipping may be overwritten. By employing such a configuration, it becomes possible to learn the actual power consumption in accordance with the place where the power consumption measuring apparatus 100 is actually disposed and the period of use thereof, thereby further enhancing the measurement accuracy of the power consumption.

The power consumption measuring apparatus 100 of the above-explained embodiments can be realized by not only an exclusive system but also a general-purpose computer system. For example, the program 19 for executing the above-explained operations may be distributed in a manner stored in a computer-readable recording medium (such as a flexible disk, a CD-ROM, or a DVD-ROM), and may be installed in a computer to configure the power consumption measuring apparatus 100 that executes the above-explained processes. Moreover, the program 19 may be stored in a storage device of a file specifying device over a communication network like the Internet, and a general-purpose computer system may download such a program, thereby configuring the power consumption measuring apparatus 100.

When, for example, respective functions of the power consumption measuring apparatus 100 are realized by an OS (Operating System) and an application program that bear respective functions or the OS and the application program that cooperatively operate together, only the application program portion may be stored in a recording medium or a storage device.

Furthermore, the program 19 may be superimposed on carrier waves, and may be distributed over a communication network. For example, the program 19 may be posted on a bulletin board (BBS: Bulletin Board System) over the communication network, and may be distributed over the network. Next, the program 19 is activated and executed under the control of the OS like the other application programs to establish a configuration that executes the above-explained processes.

Some of or all of the above-explained embodiments can be described as the following Supplementary notes, but the present invention is not limited to the following Supplementary notes.

<Supplementary Note 1>

A power consumption measuring apparatus comprising:

a load measuring unit that obtains load information on a configuring device which configures a local power consumption measuring apparatus;

a status obtaining unit that obtains status information on the configuring device based on the load information obtained by the load measuring unit;

an actual power consumption obtaining unit that obtains actual power consumption actually consumed by the local power consumption measuring apparatus;

a power consumption learning unit that obtains a correlation between the load information and the actual power consumption for each status information based on the load information obtained by the load measuring unit, the status information obtained by the status obtaining unit, and the actual power consumption obtained by the actual power consumption obtaining unit; and

a power consumption estimating unit that obtains estimated power consumption of the local power consumption measuring apparatus from the correlation obtained by the power consumption learning unit based on the load information obtained by the load measuring unit, and the status information obtained by the status obtaining unit.

<Supplementary Note 2>

The power consumption measuring apparatus according to Supplementary note 1, further comprising a status information storing unit that stores a status identifier for identifying a status of the configuring device and the load information in association with each other, wherein the status obtaining unit obtains the status identifier associated with the load information stored in the status information storing unit based on the load information obtained by the load measuring unit.

<Supplementary Note 3>

The power consumption measuring apparatus according to Supplementary note 1 or 2, wherein the load measuring unit and the status obtaining unit keep obtaining the load information and the status information until a predetermined amount of data necessary for allowing the power consumption learning unit to obtain the correlation is accumulated.

<Supplementary Note 4>

The power consumption measuring apparatus according to Supplementary note 3, further comprising a load applying unit that applies load set in advance to the configuring device at a predetermined timing,

wherein the load applying unit keeps applying load set in advance to the configuring device until the predetermined amount of data necessary for allowing the power consumption learning unit to obtain the correlation is accumulated.

<Supplementary Note 5>

The power consumption measuring apparatus according to any one of Supplementary notes 1 to 4, wherein

the power consumption learning unit obtains a linear approximation formula for the load information obtained by the load measuring unit and the actual power consumption obtained by the actual power consumption obtaining unit for each status information obtained by the status obtaining unit, and

the power consumption measuring apparatus further comprises a learning result storing unit that stores the liner approximation formula obtained by the power consumption learning unit in association with the status information.

<Supplementary Note 6>

The power consumption measuring apparatus according to Supplementary note 5, wherein the power consumption estimating unit

obtains the linear approximation formula stored in the learning result storing unit in association with the status information based on the status information obtained by the status obtaining unit, and

applies the load information obtained by the load measuring unit to the obtained linear approximation formula to obtain the estimated power consumption.

<Supplementary Note 7>

The power consumption measuring apparatus according to Supplementary note 5 or 6, wherein the power consumption learning unit obtains the linear approximation formula for the load information obtained by the load measuring unit and the actual power consumption obtained by the actual power consumption obtaining unit through a least square technique.

<Supplementary Note 8>

The power consumption measuring apparatus according to any one of Supplementary notes 1 to 7, wherein

the configuring device comprises a CPU and an HDD,

the load measuring unit obtains a CPU use rate of the CPU and an HDD traffic of the HDD,

the status obtaining unit obtains the status identifier for identifying the status of the configuring device based on the HDD traffic obtained by the load measuring unit,

the power consumption learning unit obtains a correlation between the CPU use rate and the actual power consumption for each status identifier based on the CPU use rate obtained by the load measuring unit, the status identifier obtained by the status obtaining unit, and the actual power consumption obtained by the actual power consumption obtaining unit, and

the power consumption estimating unit obtains estimated power consumption of the local power consumption measuring apparatus from the correlation obtained by the power consumption learning unit based on the CPU use rate obtained by the load measuring unit, and the status identifier obtained by the status obtaining unit.

<Supplementary Note 9>

A power consumption measuring method comprising:

a load measuring step of obtaining load information on a configuring device which configures a local apparatus;

a status obtaining step of obtaining status information on the configuring device based on the load information obtained through the load measuring step;

an actual power consumption obtaining step of obtaining actual power consumption actually consumed by the local apparatus;

a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and

a power consumption estimating step of obtaining estimated power consumption of the local apparatus from the correlation obtained through the power consumption learning step based on the load information obtained through the load measuring step, and the status information obtained through the status obtaining step.

<Supplementary Note 10>

A computer-readable memory medium having stored therein a program that allows a computer to execute:

a load measuring step of obtaining load information on a configuring device which configures a local apparatus;

a status obtaining step of obtaining status information on the configuring device based on the load information obtained through the load measuring step;

an actual power consumption obtaining step of obtaining actual power consumption actually consumed by the local apparatus;

a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and

a power consumption estimating step of obtaining estimated power consumption of the local apparatus from the correlation obtained through the power consumption learning step based on the load information obtained through the load measuring step, and the status information obtained through the status obtaining step.

What is claimed is:

1. A power consumption measuring apparatus comprising:
a load measuring unit that obtains load information on a configuring device which configures a local power consumption measuring apparatus;
a status obtaining unit that obtains status information on the configuring device based on the load information obtained by the load measuring unit;
an actual power consumption obtaining unit that obtains actual power consumption actually consumed by the local power consumption measuring apparatus;
a power consumption learning unit that obtains a correlation between the load information and the actual power consumption for each status information based on the load information obtained by the load measuring unit, the status information obtained by the status obtaining unit, and the actual power consumption obtained by the actual power consumption obtaining unit; and
a power consumption estimating unit that obtains estimated power consumption of the local power consumption measuring apparatus from the correlation obtained by the power consumption learning unit based on the load information obtained by the load measuring unit, and the status information obtained by the status obtaining unit.

2. The power consumption measuring apparatus according to claim 1, further comprising a status information storing unit that stores a status identifier for identifying a status of the configuring device and the load information in association with each other,
wherein the status obtaining unit obtains the status identifier associated with the load information stored in the status information storing unit based on the load information obtained by the load measuring unit.

3. The power consumption measuring apparatus according to claim 1, wherein the load measuring unit and the status obtaining unit keep obtaining the load information and the status information until a predetermined amount of data necessary for allowing the power consumption learning unit to obtain the correlation is accumulated.

4. The power consumption measuring apparatus according to claim 3, further comprising a load applying unit that applies load set in advance to the configuring device at a predetermined timing,
wherein the load applying unit keeps applying load set in advance to the configuring device until the predetermined amount of data necessary for allowing the power consumption learning unit to obtain the correlation is accumulated.

5. The power consumption measuring apparatus according to claim 1, wherein
the power consumption learning unit obtains a linear approximation formula for the load information obtained by the load measuring unit and the actual power consumption obtained by the actual power consumption obtaining unit for each status information obtained by the status obtaining unit, and
the power consumption measuring apparatus further comprises a learning result storing unit that stores the liner approximation formula obtained by the power consumption learning unit in association with the status information.

6. The power consumption measuring apparatus according to claim 5, wherein the power consumption estimating unit
obtains the linear approximation formula stored in the learning result storing unit in association with the status information based on the status information obtained by the status obtaining unit, and
applies the load information obtained by the load measuring unit to the obtained linear approximation formula to obtain the estimated power consumption.

7. The power consumption measuring apparatus according to claim 5, wherein the power consumption learning unit obtains the linear approximation formula for the load information obtained by the load measuring unit and the actual power consumption obtained by the actual power consumption obtaining unit through a least square technique.

8. The power consumption measuring apparatus according to claim 1, wherein
the configuring device comprises a CPU and an HDD,
the load measuring unit obtains a CPU use rate of the CPU and an HDD traffic of the HDD,
the status obtaining unit obtains the status identifier for identifying the status of the configuring device based on the HDD traffic obtained by the load measuring unit,
the power consumption learning unit obtains a correlation between the CPU use rate and the actual power consumption for each status identifier based on the CPU use rate obtained by the load measuring unit, the status identifier obtained by the status obtaining unit, and the actual power consumption obtained by the actual power consumption obtaining unit, and
the power consumption estimating unit obtains estimated power consumption of the local power consumption measuring apparatus from the correlation obtained by the power consumption learning unit based on the CPU use rate obtained by the load measuring unit, and the status identifier obtained by the status obtaining unit.

9. A power consumption measuring method comprising:
a load measuring step of obtaining load information on a configuring device which configures a local apparatus;
a status obtaining step of obtaining status information on the configuring device based on the load information obtained through the load measuring step;
an actual power consumption obtaining step of obtaining actual power consumption actually consumed by the local apparatus;
a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and
a power consumption estimating step of obtaining estimated power consumption of the local apparatus from the correlation obtained through the power consumption learning step based on the load information obtained through the load measuring step, and the status information obtained through the status obtaining step.

10. A computer-readable memory medium having stored therein a program that allows a computer to execute:
a load measuring step of obtaining load information on a configuring device which configures a local apparatus;
a status obtaining step of obtaining status information on the configuring device based on the load information obtained through the load measuring step;
an actual power consumption obtaining step of obtaining actual power consumption actually consumed by the local apparatus;
a power consumption learning step of obtaining a correlation between the load information and the actual power consumption for each status information based on the load information obtained through the load measuring step, the status information obtained through the status obtaining step, and the actual power consumption obtained through the actual power consumption obtaining step; and
a power consumption estimating step of obtaining estimated power consumption of the local apparatus from the correlation obtained through the power consumption learning step based on the load information obtained through the load measuring step, and the status information obtained through the status obtaining step.
